(19) United States
(12) Patent Application Publication
(10) Pub. No.: US 2023/0029196 A1
(43) Pub. Date: Jan. 26, 2023

(54) METHOD AND APPARATUS RELATED TO SENTENCE GENERATION

(71) Applicant: XRSPACE CO., LTD., Taoyuan City (TW)

(72) Inventor: Chun-Yu Huang, Taipei City (TW)

(73) Assignee: XRSPACE CO., LTD., Taoyuan City (TW)

(21) Appl. No.: 17/382,360

(22) Filed: Jul. 22, 2021

(51) Int. Cl. G06F 40/284; G06F 40/166

(52) U.S. Cl. CPC G06F 40/284; G06F 40/166

(57) ABSTRACT

A method and an apparatus related to sentence generation are provided. In the method, a known token is determined based on a first sentence. A second sentence is determined based on the known token and a first masked token through a language model. The first masked token and the known token are inputted into the language model, to determine a first predicted token corresponding to the first masked token. The language model is trained based on an encoder of a bidirectional transformer. A second masked token is inserted when the determined result of the first predicted token is determined. The second masked token is inputted into the language model, to determine a second predicted token corresponding to the second masked token. The second sentence includes the first predicted token, the second predicted token and the known token. The second sentence is a sentence to respond to the first sentence.

### BACKGROUND OF THE DISCLOSURE

### 1. Field of the Disclosure

The present disclosure generally relates to natural language processing (NLP), in particular, to a method and an apparatus related to sentence generation.

### 2. Description of Related Art

In natural language processing (NLP), it may try to find out the interactions between computers and human language, and it may further process and analyze large amounts of natural language data. It should be noticed that natural language generation (NLG) is a sub-field of NLP. NLG is trying to understand the input sentence to produce the machine representation language and further convert a representation into words.

However, it is still a large challenge for providing a proper response in human conversation. For example, for slot filling, the number of the slot for filling word may be fixed, it the sentence after the slot filling may not be proper.

### SUMMARY OF THE DISCLOSURE

Accordingly, the present disclosure is directed to a method and an apparatus related to sentence generation, to provide a proper response with flexible length.

In one of the exemplary embodiments, a method, includes, but is not limited thereto, the following steps. A known token is determined based on a first sentence. A second sentence is determined based on the known token and a first masked token through a language model. The first masked token and the known token are inputted into the language model, to determine a first predicted token corresponding of the first masked token. The language model is trained based on an encoder of a bidirectional transformer. A second masked token is inserted when the determined result of the first predicted token is determined. The second masked token is inputted into the language model, to determine a second predicted token corresponding to the second masked token. The second sentence includes the first predicted token, the second predicted token and the known token. The second sentence is a sentence to respond to the first sentence.

In one of the exemplary embodiments, an apparatus, includes, but is not limited thereto, a memory and a processor. The memory is used for storing program code. The processor is coupled to the memory. The processor is configured for loading and executing the program code to perform the following steps. A known token is determined based on a first sentence. A second sentence is determined based on the known token and a first masked token through a language model. The first masked token and the known token are inputted into the language model, to determine a first predicted token corresponding to the first masked token. The language model is trained based on an encoder of a bidirectional transformer. A second masked token is inserted when the determined result of the first predicted token is determined. The second masked token is inputted into the language model, to determine a second predicted token corresponding to the second masked token. The second sentence includes the first predicted token, the second predicted token and the known token. The second sentence is a sentence to respond to the first sentence.

It should be understood, however, that this Summary may not contain all of the aspects and embodiments of the present disclosure, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram illustrating an apparatus according to one of the exemplary embodiments of the disclosure.

FIG. 2 is a flowchart illustrating a method according to one of the exemplary embodiments of the disclosure.

FIG. 3 is a flowchart illustrating a generating method of a known token according to one of the exemplary embodiments of the disclosure.

FIG. 4 is a schematic diagram illustrating a transformer according to one of the exemplary embodiments of the disclosure.

FIG. 5 is a schematic diagram illustrating a structure of a bidirectional transformer according to one of the exemplary embodiments of the disclosure.

FIGS. 6A-6D are schematic diagrams illustrating a sentence prediction according to one of the exemplary embodiments of the disclosure.

FIG. 7 is a flowchart illustrating a generating method of a sentence according to one of the exemplary embodiments of the disclosure.

FIG. 8 is a schematic diagram illustrating a sentence prediction according to one of the exemplary embodiments of the disclosure.

FIG. 9 is a schematic diagram illustrating a structure of a unidirectional transformer according to one of the exemplary embodiments of the disclosure.

FIG. 10 is a schematic diagram illustrating a sentence prediction according to one of the exemplary embodiments of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

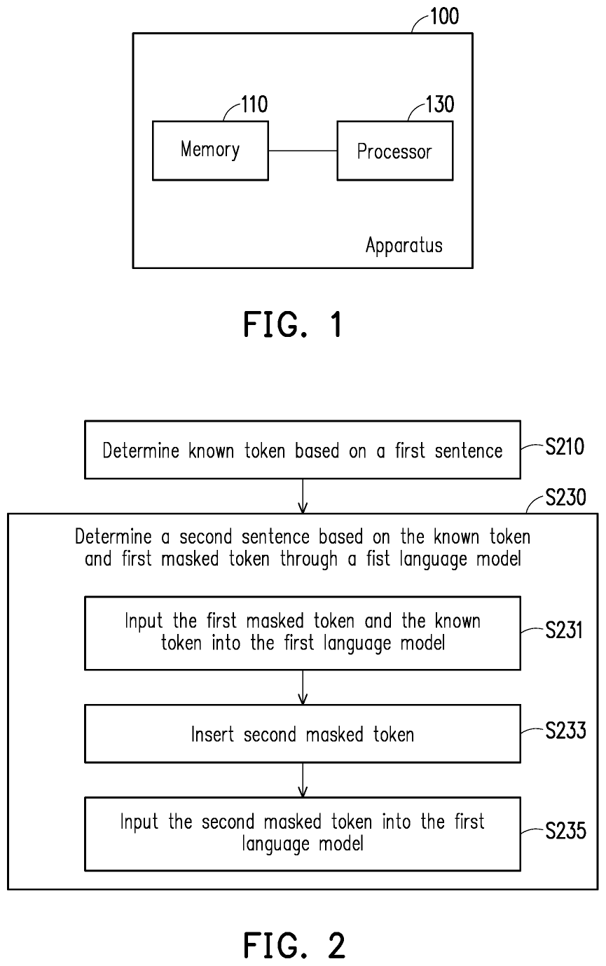

FIG. 1 is a block diagram illustrating an apparatus 100 according to one of the exemplary embodiments of the disclosure. Referring to FIG. 1, the apparatus 100 includes, but is not limited thereto, a memory 110 and a processor 130. In one embodiment, the apparatuses 100 could be a head-mounted display (HMD), a computer, a server, a smartphone, a tablet computer, a smartwatch, a home hub, or the likes. In some embodiments, the apparatus 100 is adapted for XR or other reality-related technologies.

The memory 110 may be any type of a fixed or movable random-access memory (RAM), a read-only memory (ROM), a flash memory, a similar device, or a combination of the above devices. In one embodiment, the memory 110 is used to store program codes, device configurations, buffer data, or permanent data (such as sentence, token, or keyword), and these data would be introduced later.

The processor 130 is coupled to the memory 110. The processor 130 is configured to load the program codes stored in the memory 110, to perform a procedure of the exemplary embodiment of the disclosure.

In some embodiments, the processor 130 may be a central processing unit (CPU), a microprocessor, a microcontroller, a graphics processing unit (GPU), a digital signal processing (DSP) chip, a field-programmable gate array (FPGA). The functions of the processor 150 may also be implemented by an independent electronic device or an integrated circuit (IC), and operations of the processor 130 may also be implemented by software.

To better understand the operating process provided in one or more embodiments of the disclosure, several embodiments will be exemplified below to elaborate the apparatus 100. The devices and modules in apparatus 100 are applied in the following embodiments to explain the method related to sentence generation provided herein. Each step of the method can be adjusted according to actual implementation situations and should not be limited to what is described herein.

FIG. 2 is a flowchart illustrating a method according to one of the exemplary embodiments of the disclosure. Referring to FIG. 2, the processor 130 may determine a known token based on a first sentence (step S210). The processor 130 may determine a second sentence based on the known token and a first masked token through a first language model (step S230). To determine the second sentence, the processor 130 may further input the first masked token and the known token into the first language model (step S231), insert a second masked token when a determined result of the first predicted token (step S233), and input the second masked token into the first language model (step S235).

Specifically, a token may present a single word or a group of words. In some embodiments, a token may be an instance of a single character or a sequence of characters. For example, a character sequence “hello, world” includes two tokens, which are “hello” and “world, after tokenization on the character sequence.

On the other hand, the first sentence could be obtained from a speech from a user, an image capturing texts, a text document, or an inputted text by a physical or virtual keyboard. For example, a speech, such as a question of a user, is recorded, and a corresponding sentence is obtained by speech-to-text function. For another example, an image is captured, and a corresponding sentence is obtained by optical character recognition (OCR).

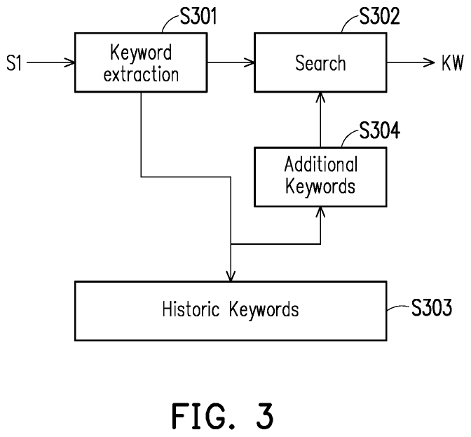

In step 210, the known token is determined based on a first sentence. For example, FIG. 3 is a flowchart illustrating a generating method of a known token according to one of the exemplary embodiments of the disclosure. Referring to FIG. 3, the processor 130 may extract one or more keywords from the first sentence S1 (step S301). For example, the first sentence S1 is “It's cold today.” The keywords could be “cold” and “today”. In one embodiment, there may be one or more predefined keywords. The processor 130 may compare the first sentence S1 with the predefined keywords. In one embodiment, the processor 130 may extract noun, verb, adjective, adverb and/or other categories from the first sentence S1 for the keywords. In some embodiments, the processor 130 may use co-occurance method, topic modeling, term frequency-inverse document frequency (TF-IDF), rapid automatic keyword extraction (RAKE), machine learning-based extraction, or other key extraction algorithms to determine the keyword.

The processor 130 may search the known token KW based on the keyword (step S302). In one embodiment, a look-up table may record a relation between keywords and known tokens KW. The processor 130 may search one or more corresponding keywords KW with high confidence/probability in the look-up table. In one embodiment, the processor 130 may use a machine learning model (such as bidirectional embedding representations from transformers (BERT), Stanford question answering dataset (SQuAD), or hugging face transformers) to predict the known token KW based on the keyword as an input. For example, the keywords are “cold” and “today”, and the known token KW would be “launch” and “hot pot”. In some embodiments, the machine learning model may further be used to determine the known token KW from the first sentence S1 directly. For example, the first sentence is “It's cold today”, and the known token KW would be “night” and “hot spring”.

In one embodiment, the processor 130 may extract an additional keyword from a previous conversation. The previous conversation is a group of sentences produced by a user, the apparatus 100, and/or other apparatuses at the time before the first sentence. The processor 130 may extract one or more historic keywords from the previous conversation based on the aforementioned keyword extraction methods or other keyword extraction methods (step S303). In some embodiments, the keyword extracted from the first sentence could become one historic keyword. The processor 130 may select one or more additional keywords from the historic keywords (step S304). That is, the additional keyword is one of the historic keywords.

The processor 130 may search the known token KW based on the additional keyword (step S302). The search method could be the aforementioned method or other methods. In some embodiments, the processor 130 may search the known token KW based on the keywords from both the first sentence S1 and the historic keywords.

After the known token is determined, in step S230, the processor 130 may determine a second sentence based on the known token and a first masked token through a first language model. Specifically, the second sentence is a sentence to respond to the first sentence. For example, the first sentence is a question, and the second sentence is an answer of the question. For another example, the first sentence and the second sentence could be a conversation.

In addition, the first language model used to predict the second sentence could be a machine learning model and is trained based on an encoder of a bidirectional transformer. The machine learning model may be a neural language model, which uses continuous representations or embeddings of words to make their predictions based on neural networks.

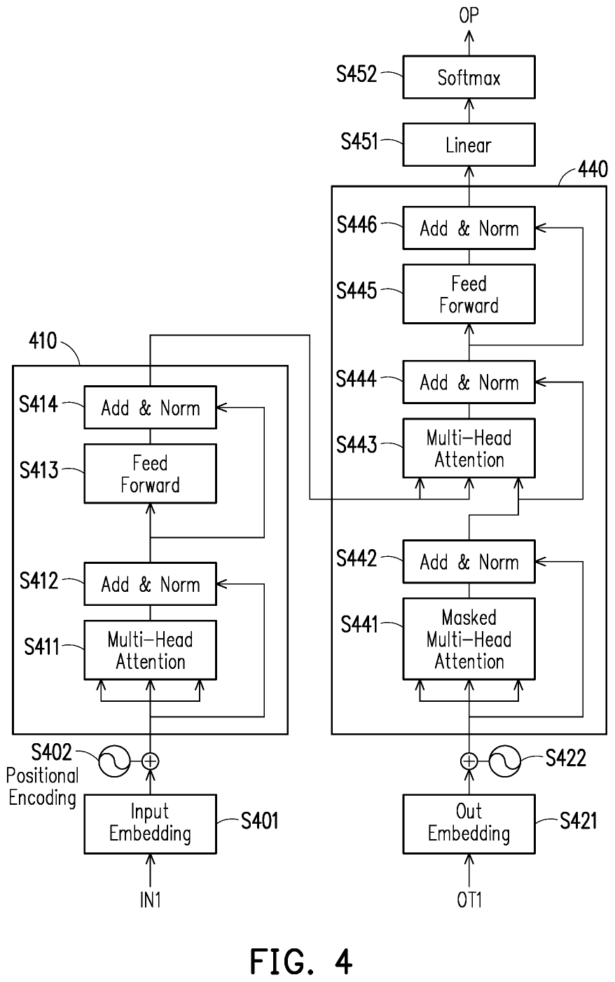

For example, the transformer is one of the machine learning models. FIG. 4 is a schematic diagram illustrating a transformer according to one of the exemplary embodiments of the disclosure. Referring to FIG. 4, the transformer includes one or more encoders 410 and one or more decoders 440. At first, an input word IN1 would be pre-processed. The input word IN1 could be the known token KW of FIG. 3. The vector of the input word IN1 would be obtained through token embedding (step S401). The vector represents the input word IN1.

Different words have different vectors. The positioning information of the input word IN1 would be obtained through positioning embedding (step S402). The positioning information is related to a position of the input word IN1 relative to other words (such as another known token or masked token). The feature vector of the input word IN1 based on the token and positioning embedding can be inputted into the encoder 410. In the encoder 410, the relation between the input word IN1 and other words would be determined through multi-head attention (step S411). For example, the weights of words corresponding to the input word IN1 are calculated, and the weighted sum of the words is determined. The add & norm includes residual connection and normalization, where the sum of the feature vector and the output of the multi-head attention is normalized (step S412). In addition, the output of add & norm is inputted into a fully connected network through the feed-forward network (step S413). Then, the add & norm is performed again (step S414).

On the other hand, the feature vector of the output OT1 of the encoder 410 is obtained as described in steps 401 and S402 (steps S421 and S422). In the decoder 440, the relation between the output OT1 and other previous words would be determined through masked multi-head attention (step S441), and the add & norm is performed again (step S442). The output of the encoder 410 would be added to be in attention (step S443), and the add & norm is performed again (step S444). The output of add & norm is inputted into a fully connected network through the feed-forward network (step S445), and the add & norm is performed again (step S446). The output of the decoder 440 is inputted into the linear layer (step S451) and softmax layer (step S452), and then a target word with the highest probability OP is determined.

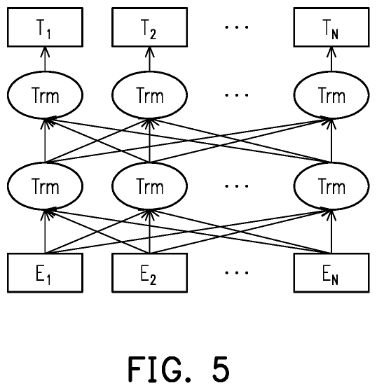

FIG. 5 is a schematic diagram illustrating a structure of a bidirectional transformer according to one of the exemplary embodiments of the disclosure. Referring to FIG. 5, regarding the bidirectional transformer, embeddings E₁˜E_{N} of multiple words are inputted into the transformers Trm, where N is an integer. Each transformer Trm could be the transformer of FIG. 4. It should be noticed that the contextual representation of each token is the concatenation of the left-to-right and right-to-left representations. Then, the feature vectors T₁˜T_{N} of the embeddings E₁˜E_{N} are determined.

In one embodiment, the first language model is a bidirectional encoder representations from transformers (BERT) model. In one embodiment, the first language model is DistilBERT, Bidirectional Gated Recurrent Unit (BGRU), or other transformers.

In one embodiment, the second sentence is configured to include the known token and the first masked token. That is, the known token and the first masked token are filled in the second sentence. Furthermore, a masked token is a token that has not been predicted/determined.

To fill one or more tokens in the second sentence, in step S231, the processor 130 may input the first masked token and the known token into the first language model, to determine a first predicted token corresponding to the first masked token. Specifically, the processor 130 or another processor may pre-train the first language model for masked word prediction. In the pre-training task, the final hidden vectors corresponding to the masked tokens are fed into an output softmax over the vocabulary, as in a standard language model (LM). One or more tokens in a sequence would be masked at random, and the masked tokens are considered as training samples to train the first language model. Therefore, the first predicted token corresponding to the first masked token, which is the masked tokens in the second sentence, can be predicted. Taking BERT as an example, the feature vector of the first masked token would be inputted into a linear multi-class classifier, to predict what word is the first masked token. The predicted word corresponding to the first masked token is the first predicted token.

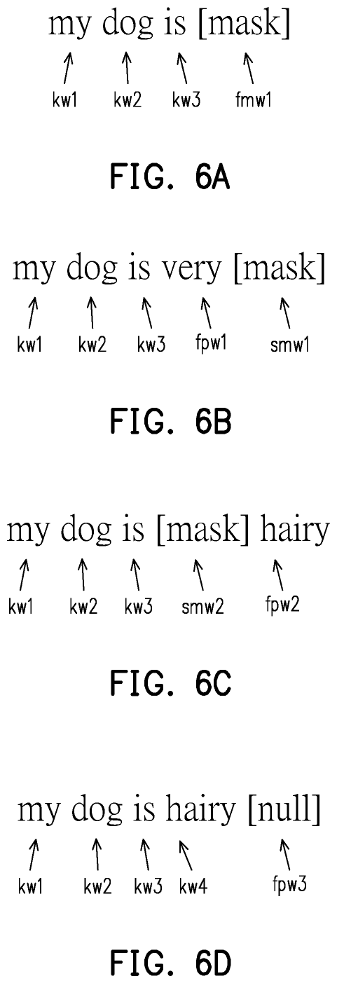

For example, FIGS. 6A-6D are schematic diagrams illustrating a sentence prediction according to one of the exemplary embodiments of the disclosure. Referring to FIG. 6A, “my”, “dog”, and “is” are three known tokens kw1˜kw3. It is assumed the second sentence includes one first masked token fmw1. Referring to FIG. 6B, after the prediction of the first language model, the first predicted token “very” is determined. It should be noticed that the positions of these token may be pre-determined. However, in some embodiments, the positions of these token may be determined by the first language model or other machine learning models.

When a determined result of the first predicted token is determined, in step S233, the processor 130 may insert a second masked token. Specifically, the second masked token is another masked token different from the first masked token. The second sentence is pre-configured with merely the known token and the first masked token and without the second masked token. However, the second sentence merely including the known token and the first predicted token may not be proper. Taking FIG. 6B as an example, the second sentence may be not completed.

In one embodiment, the processor 130 may determine whether the determined result is that the first predicted token is null. The null is related to the termination of token prediction. For example, if the highest probability of word outputted from the first language model is less than a threshold such as 10%, 5%, or 3%, the first predicted token would be null. For another example, null has the highest probability after the prediction, the first predicted token would be null. When the first predicted token is not null, the processor 150 may insert the second masked token for the second sentence. For example, the word with the highest probability is not null.

Taking FIG. 6B as an example, the first predicted token fpw1 is “very” and is not null, the processor 130 may insert the second masked token smw1 to be subsequent to the first predicted token fpw1. Taking FIG. 6C as another example, the first predicted token fpw2 is “hairy” and is not null, the processor 130 may insert the second masked token smw2 to be antecedent to the first predicted token fpw2.

On the other hand, when the first predicted token is null, the processor 130 may not or disable to insert the second masked token. It should be noticed that there may be more than one first predicted token. If all first predicted tokens in the second sentence are null, the processor 130 may terminate the prediction of the first language model.

Taking FIG. 6D as an example, it is assumed the know token kw4 is “hairy”, and the first predicted token fpw2 is null, the processor 130 may terminate the prediction by the first language model.

After the second masked token is inserted, in step S235, the processor 130 may input the second masked token into the first language model, determine a second predicted token corresponding to the second masked token. Specifically, the second masked token is inserted for the second sentence. It means that there is still a masked token that has not been determined, and the second sentence is not completed. The processor 130 may use the known token, the second masked token, and one of the first predicted token and the first masked token as the input of the first model, to predict the second predicted token. The prediction of the second predicted token may be referred to the prediction of the first predicted token, and the detailed description would be omitted.

In one embodiment, when determining the second predicted token, the processor 130 may further determine whether the second predicted token is null. When the second predicted token is not null, the processor 130 may further insert another second masked token for the second sentence at an antecedent position or a subsequent position relative to the second predicted token. On the other hand, when the second predicted token is null, the processor 130 may not insert another second masked token. It should be noticed that there may be more than one second predicted token. If all second predicted tokens in the second sentence are null, the processor 130 may terminate the prediction of the first language model.

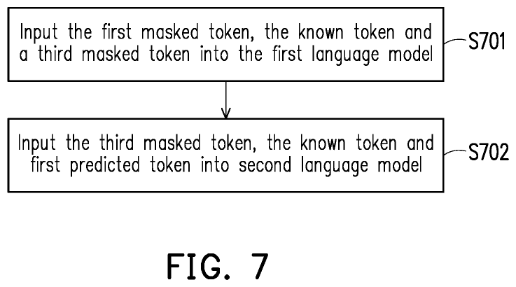

FIG. 7 is a flowchart illustrating a generating method of a sentence according to one of the exemplary embodiments of the disclosure. Referring to FIG. 7, in one embodiment, the processor 130 may input the first masked token, the known token and a third masked token into the first language model (step S710). The first predicted token is determined by the first language model. However, the processor 130 may disable determining a third predicted token corresponding to the third masked token by the first language model. The third masked token is another masked token different from the first and second masked tokens. The output of the first language model would not include the third predicted token.

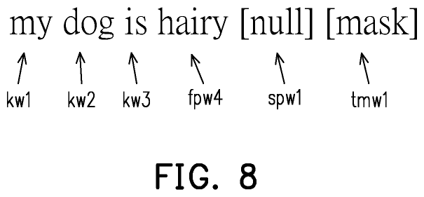

For example, FIG. 8 is a schematic diagram illustrating a sentence prediction according to one of the exemplary embodiments of the disclosure. Referring to FIG. 8, it is assumed the first predicted token fpw4 is “hairy” and the second predicted token spw1 is null, and these tokens are predicted by the first language model. However, the third masked token tmw1 is still in the second sentence, and the corresponding predicted token is not predicted by the first language model.

The processor 130 may input the first predicted token, the known token, the second predicted token (if it is determined), the third masked token into a second language model (step S730), to determine the third predicted token. Specifically, a third sentence is configured to include the known token, the first predicted token, the second predicted token (if it is determined), and the third predicted token.

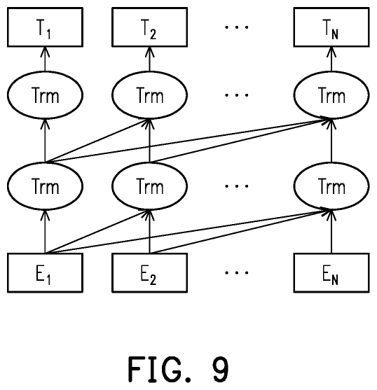

In addition, the second language model is a machine learning model and is trained based on a unidirectional transformer. FIG. 9 is a schematic diagram illustrating a structure of a unidirectional transformer according to one of the exemplary embodiments of the disclosure. Referring to FIG. 9, different from the bidirectional transformer, the contextual representation of each token is the concatenation of the left-to-right representations without the right-to-left representation. In other words, any token is in attention with one or more antecedent tokens. One of the advantages of the second language model is that it is good for completing a sentence.

In one embodiment, the second language model is any version of a generative pre-trained transformer (GPT) model. In one embodiment, the second language model is unified pre-trained language model (uniLM), T5, bidirectional and auto-regressive transformers (BART), or other unidirectional models.

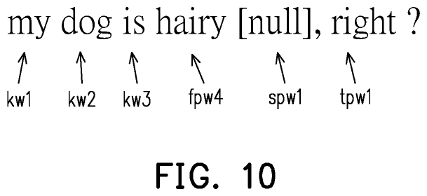

For example, FIG. 10 is a schematic diagram illustrating a sentence prediction according to one of the exemplary embodiments of the disclosure. Referring to FIG. 10, the third predicted token tpw1 is determined as “right ?” based on the antecedent tokens kw1˜kw4, fpw4, and spw1.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method, comprising:
determining a known token based on a first sentence; and
determining a second sentence based on the known token and a first masked token through a first language model, wherein determining the second sentence comprises:
inputting the first masked token and the known token into the first language model, to determine a first predicted token corresponding to the first masked token, wherein the first language model is trained based on an encoder of a bidirectional transformer;
inserting a second masked token when a determined result of the first predicted token is determined; and
inputting the second masked token into the first language model, to determine a second predicted token corresponding to the second masked token, wherein the second sentence comprises the first predicted token, the second predicted token and the known token, and the second sentence is a sentence to respond to the first sentence.

2. The method according to claim 1, wherein inserting the second masked token comprises:
determining whether the determined result is that the first predicted token is null, wherein the null is related to a termination of token prediction;
inserting the second masked token when the first predicted token is not the null; and
not inserting the second masked token when the first predicted token is the null.

3. The method according to claim 1, wherein inserting the second masked token comprises:
inserting the second masked token to be antecedent to the first predicted token or be subsequent to the first predicted token.

4. The method according to claim 1, wherein inputting the second masked token into the first language model comprises:
determining whether the second predicted token is null, wherein the null is related to a termination of token prediction;
inserting another second masked token when the second predicted token is not the null; and
not inserting the another second masked token when the second predicted token is the null.

5. The method according to claim 1, wherein inputting the first masked token and the known token into the first language model comprises:
inputting a third masked token into the first language model, comprising:
disabling determining a third predicted token corresponding to the third masked token by the first language model.

6. The method according to claim 5, after inputting the second masked token into the first language model, the method further comprises:
inputting the first predicted token, the known token, and the third masked token into a second language model, to determine the third predicted token, wherein the second language model is trained based on a unidirectional transformer, and a third sentence comprises the known token, the first predicted token, and the third predicted token.

7. The method according to claim 1, wherein determining the known token based on the first sentence comprises:
extracting a keyword from the first sentence; and
searching the known token based on the keyword.

8. The method according to claim 7, further comprising:
extracting an additional keyword from a previous conversation; and
searching the known token based on the additional keyword.

9. The method according to claim 1, wherein the first language model is a bidirectional encoder representations from transformers (BERT) model.

10. The method according to claim 6, wherein the second language model is a generative pre-trained transformer (GPT) model.

11. An apparatus, comprising:
a memory, storing a program code; and
a processor, coupled to the memory, and configured to load and execute the program code to perform:
determining a known token based on a first sentence; and
determining a second sentence based on the known token and a first masked token through a first language model, comprising:
inputting the first masked token and the known token into the first language model, to determine a first predicted token corresponding to the first masked token, wherein the first language model is trained based on an encoder of a bidirectional transformer;
inserting a second masked token when a determined result of the first predicted token is determined; and
inputting the second masked token into the first language model, to determine a second predicted token corresponding to the second masked token, wherein the second sentence comprises the first predicted token, the second predicted token and the known token, and the second sentence is a sentence to respond to the first sentence.

12. The apparatus according to claim 11, wherein the processor is further configured for:
determining whether the determined result is that the first predicted token is null, wherein the null is related to a termination of token prediction;
inserting the second masked token when the first predicted token is not the null; and
not inserting the second masked token when the first predicted token is the null.

13. The apparatus according to claim 11, wherein the processor is further configured for:
inserting the second masked token to be antecedent to the first predicted token or be subsequent to the first predicted token.

14. The apparatus according to claim 11, wherein the processor is further configured for:
determining whether the second predicted token is null, wherein the null is related to a termination of token prediction;
inserting another second masked token when the second predicted token is not the null; and
not inserting the another second masked token when the second predicted token is the null.

15. The apparatus according to claim 11, wherein the processor is further configured for:
inputting a third masked token into the first language model, comprising:
disabling determining a third predicted token corresponding to the third masked token by the first language model.

16. The apparatus according to claim 15, wherein the processor is further configured for:
inputting the first predicted token, the known token, and the third masked token into a second language model, to determine the third predicted token, wherein the second language model is trained based on a unidirectional transformer, and a third sentence comprises the known token, the first predicted token, and the third predicted token.

17. The apparatus according to claim 11, wherein the processor is further configured for:
extracting a keyword from the first sentence; and
searching the known token based on the keyword.

18. The apparatus according to claim 17, wherein the processor is further configured for:
extracting an additional keyword from a previous conversation; and
searching the known token based on the additional keyword.

19. The apparatus according to claim 11, wherein the first language model is a bidirectional encoder representations from transformers (BERT) model.

20. The apparatus according to claim 16, wherein the second language model is a generative pre-trained transformer (GPT) model.
